(19) United States
(12) Patent Application Publication
(10) Pub. No.: US 2018/0220493 A1
(43) Pub. Date: Aug. 2, 2018

(54) Adjustable Warming Blanket

(71) Applicant: Paul R. Wade, Manchester, ME (US)

(72) Inventor: Paul R. Wade, Manchester, ME (US)

(21) Appl. No.: 15/417,801

(22) Filed: Jan. 27, 2017

(51) Int. Cl. H05B 3/34

(52) U.S. Cl. CPC H05B 3/342

(57) ABSTRACT

An adjustable warming blanket with a smooth, glossy fabric layer and a fabric layer made of a soft napped material, particularly useful for warming the extremities of an individual, the fabric layers forming a two-layer rectangular fabric structure utilizing a zipper arrangement to adjust the configuration and size of the blanket.

### BACKGROUND OF THE INVENTION

### Field of the Invention

The present invention pertains to warming blankets and, in particular, to warming blankets that are adjustable in size and configuration to keep parts of the body warm as desired.

### Brief Discussion of the Related Art

Blankets are typically of a size to cover the entire body of an individual. Thus, prior art blankets have been bulky, difficult to carry and difficult to use due to folding or arranging the blankets to cover the body. A particular problem exists where the individual is sufficiently warm but requires warmth for extremities, such as the feet.

Prior art blankets are typically made of a single ply of fabric and, thus, are difficult to use in combination with other warming devices and are not adaptable for use with specific parts of the body. Particularly, folding prior art blankets to reduce size creates an awkward bulky arrangement.

### SUMMARY OF THE INVENTION

A primary aspect of the present invention is to provide a warming blanket that is easily adjustable by a user in size and configuration to keep parts of the body warm as desired.

Another aspect of the present invention is to utilize zippers, to adjustably join edges of fabric in a two-layer rectangular fabric structure of an adjustable warming blanket that has a slippery layer and a layer of napped material.

A further aspect of the present invention is to provide an insulated, comfortable, reversible, portable, adjustable blanket that can be utilized to warm extremities, such as feet, arms and legs, using an individual's own body heat instead of requiring an outside source of heat, such as electricity.

Some of the advantages of the present invention over the prior art are that, due to the particular fabric construction of the adjustable warming blanket, the adjustable warming blanket is useful in cold offices to warm feet, useful by hunters or others spending substantial time in the outdoors to keep their feet warm, useful for sitting outdoors on a cold day or night, useful for spectators at outdoor sporting events, such as football games, soccer and the like, useful inside sleeping bags and bedding to provide additional warmth for the feet and the legs, useful in transportation, such as planes, trains, automobiles, buses and the like due to the compact configuration, useful as a shoulder wrap when fully extended, useful in beds between the sheets due to the satin-smooth outer layer which facilitates free movement, can be reversible, can easily permit change of color combinations, can be made of waterproof fabric materials and, due to its small, compact size, is easy to carry and/or pack.

The present invention is generally characterized in an adjustable warning blanket formed of a two-layer rectangular fabric structure having opposing longitudinal ends and having widthwise edges joined together by stitching at a first of the longitudinal ends, with the fabric structure being filled with fiber filling disposed between the two fabric layers and confined in triangular sections formed by angled rows of stitches, and a zipper arrangement, permitting adjustment of the size and configuration of the adjustable warming blanket.

Other aspects, advantages and benefits of the present invention will become apparent from the following detailed description of the invention taken in conjunction with the accompanying drawings.

### BRIEF DESCRIPTION OF THE DRAWINGS

FIG. 1 is a perspective view of the adjustable warming blanket of the present invention in a compact configuration.

FIGS. 2 and 3 are plan views of opposing sides, respectively, of the adjustable warming blanket of the present invention in an extended configuration.

FIG. 4 is a perspective view of the adjustable warming blanket of the present invention in the extended configuration with a portion thereof folded upon itself.

FIG. 5 is a broken sectional view of the fabric structure of the adjustable warming blanket of the present invention illustrating the construction of the two-layer fabric structure with a fiber filling disposed between inner and outer fabric layers in triangular sections defined by angled rows of stitches.

FIG. 6 is a perspective view showing use of the adjustable warming blanket of the present invention for receiving lower extremities of an individual.

### DETAILED DESCRIPTION OF THE INVENTION

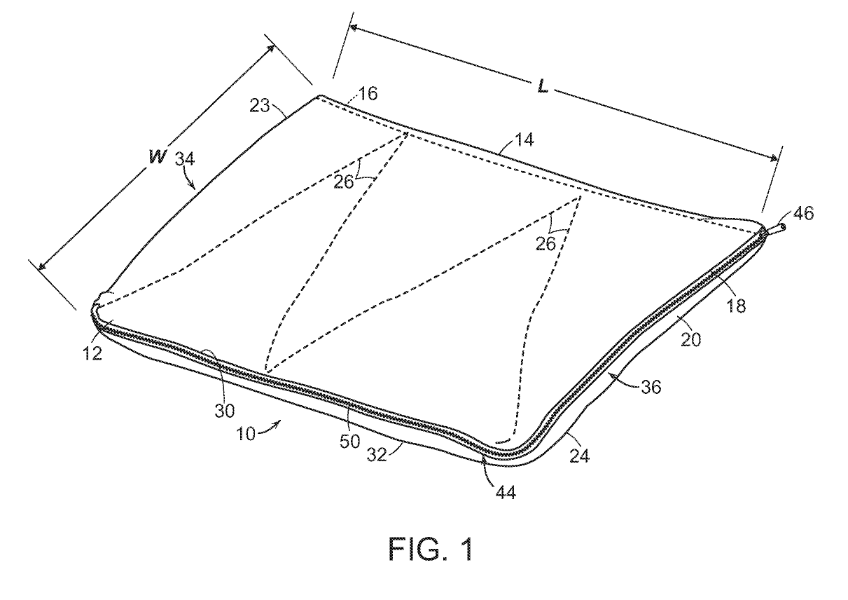

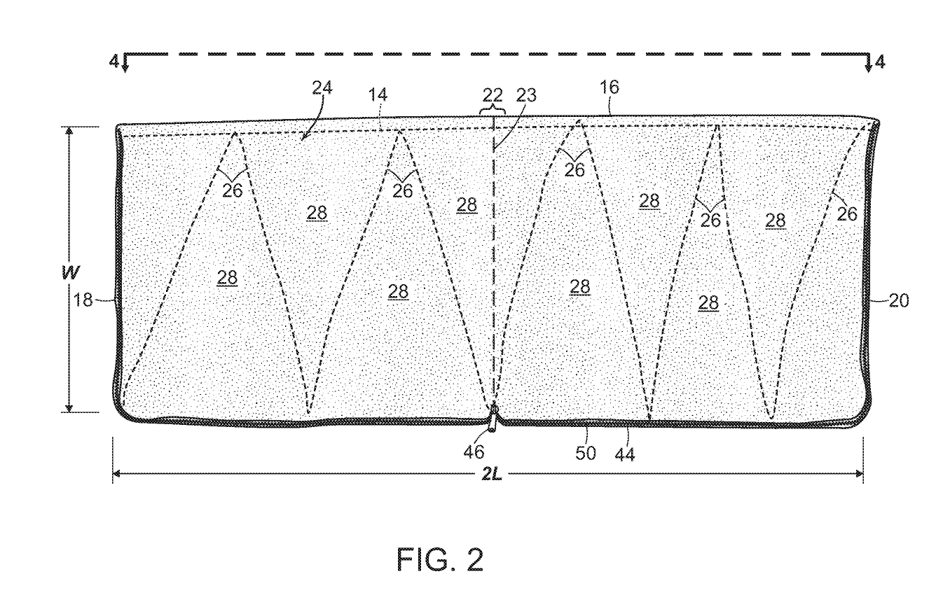

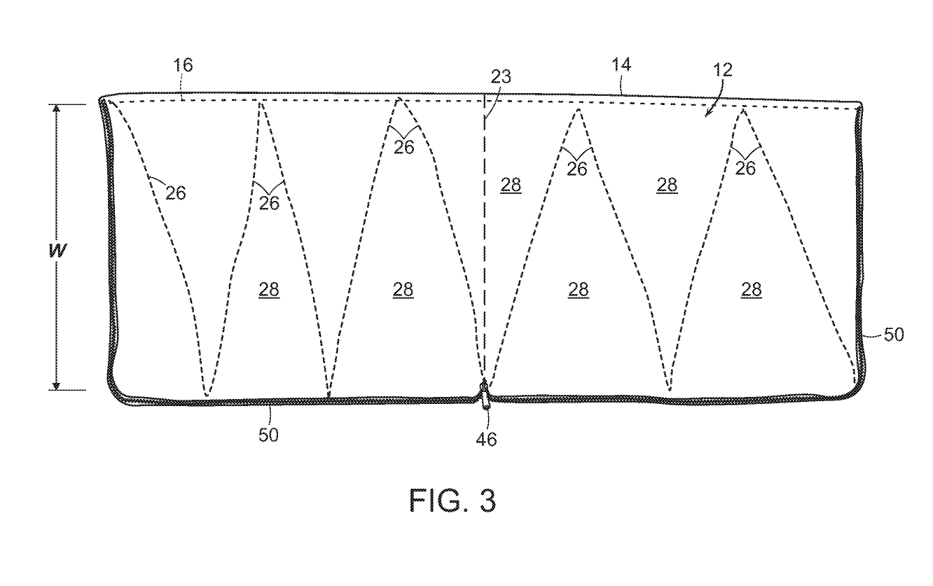

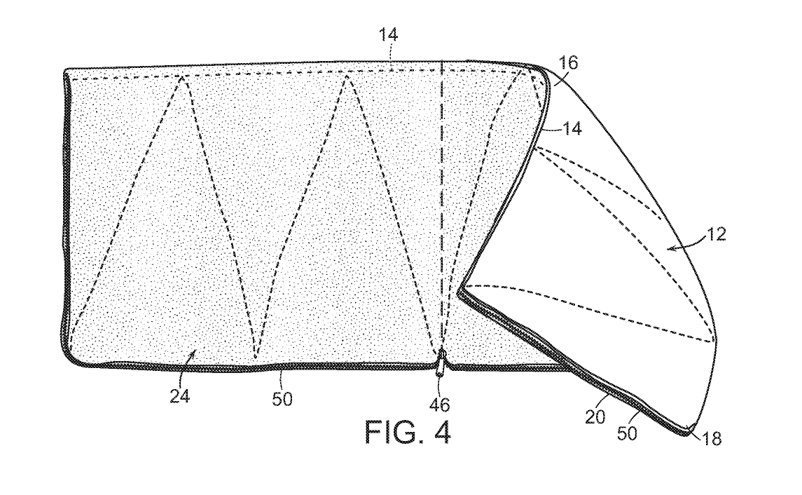

An adjustable warming blanket 10 in accordance with the present invention is shown in FIG. 1 in a closed or zippered compact configuration and shown in an open or unzipped extended configuration in FIGS. 2 and 3. The blanket is a two-layer rectangular fabric structure having a length L and a width W in the compact configuration such that the adjustable warming blanket can be easily carried or packed into travel bags, such as suitcases or hanging bags. In the compact configuration, the length L is larger than the width W; and, in the extended configuration, the length is substantially double the length L in the compact configuration, i.e. 2L.

The blanket 10 is formed of an outer fabric layer 12 made of a smooth glossy material having a soft, slippery texture and an inner fabric layer 24 made of a soft napped material. The outer and inner layers 12 and 24 have a width and a length larger than the width to produce a rectangular configuration. The outer fabric layer 12 has parallel, opposed longitudinal edges 14 and 16 extending along the length thereof and has parallel, opposed widthwise edges 18 and 20 extending along the width thereof. A central section 22 extends widthwise across the outer layer such that the blanket 10 can be folded along a line 23 centrally located in section 22 to achieve the compact configuration illustrated in FIG. 1. The inner fabric layer 24 is coextensive with the outer fabric layer 12 such that longitudinal edges 30 and 32 of the inner fabric layer 24 are juxtaposed, respectively, with longitudinal edges 14 and 16 of outer fabric layer 12.

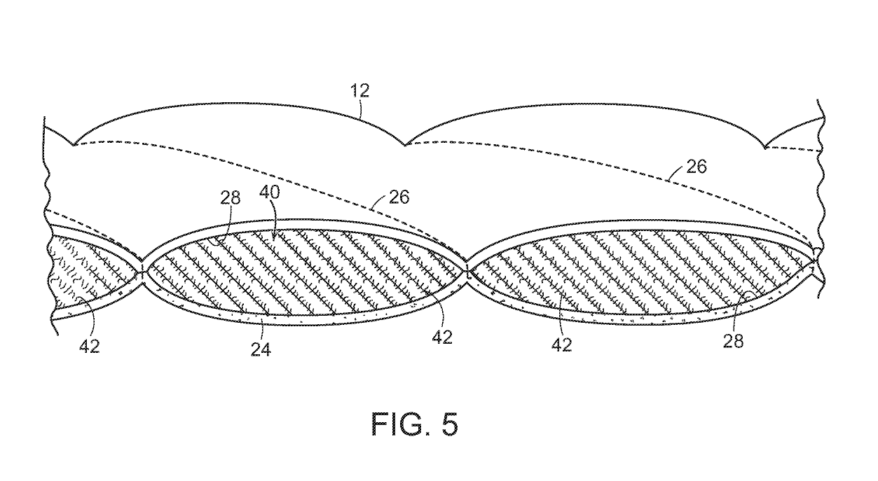

The outer and inner fabric layers 12 and 24 are fastened together at the longitudinal and widthwise edges, such as by stitching, adhesive or heating to form a temperature insulating chamber or pocket structure 40 therebetween as best shown in FIG. 5. The chamber structure 40 is filled with a fiber filling 42 made of synthetic fiber, such as polyester, sometimes referred to as “fiber fill” or “poly-fill”.

The rectangular fabric inner layer 24 stitched to the outer fabric layer 12 by a series of angled rows of stitches 26 defining triangular sections 28 therebetween, forming the chamber structure 40. The inner fabric layer 24 is coextensive with the outer fabric layer 12 and has longitudinal edges juxtaposed, respectively, with longitudinal edges of the outer fabric layer and has widthwise edges juxtaposed, respectively, with widthwise edges of the fabric layer. The outer and inner fabric layers form a two-layer rectangular fabric structure having opposing first and second longitudinal ends and having widthwise edges joined together by stitching at the first longitudinal end of said fabric structure. The fiber filling is then disposed between the outer and inner fabric layers to be confined in the triangular sections 28.

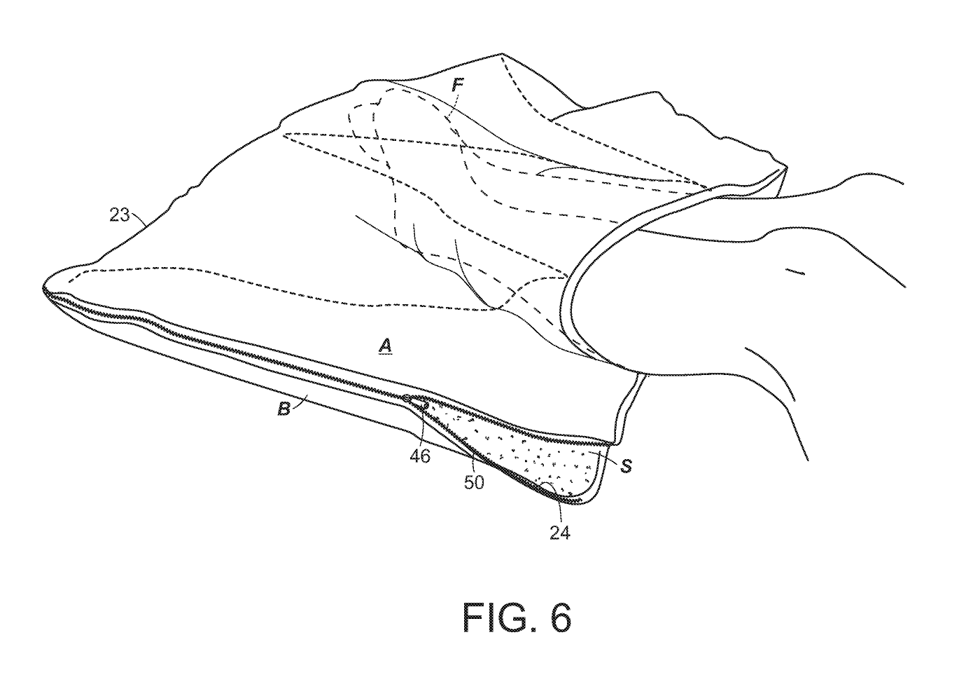

The blanket 10 has a zipper arrangement such that teeth or elements 50 of the zipper are attached to the edges of the layers, and a slider 46 is positioned along the central portion of the blanket such that, by movement of the slider, the sides of the blanket can be folded on one another along line 23 and held in place permitting the blanket to be folded into the compact configuration shown in FIG. 1 and held to permit the lower extremities of an individual to be received in the opening formed between the opposing sides as shown in FIG. 6.

The two-layer arrangement of fabric panels combined with the zipper arrangement permits adjustment of the opening within the blanket for various uses. An arrangement of the adjustable warming blanket 10 for use to warm the feet F is illustrated in FIG. 6 where the blanket is folded into a configuration along line 23 such that opposing sides A and B of the blanket form a warming surface S for receiving feet F. The size of the warming space is adjustable by moving slider 46 such that the warming effect can be controlled. For example, the zipper can be tightened such that the blanket snuggly engages the feet or loosened to permit more movement of the feet within the blanket. Accordingly, it should be appreciated that the adjustable warming blanket 10 can be used in various locations to warm extremities such as feet; and, due to the outer fabric layer being made of a smooth glossy material, the blanket can be used within normal bedding with the feet of an individual held in the soft napped inner material.

When the blanket is used with conventional bedding, the width W can be 20 inches and the length L can be 20 inches such that the blanket can be conveniently positioned relative to the bedding. The stitching is “through and through” for strength and form to keep the fiberfill in place during use and washing/cleaning. The sides and fabric layers can be reversible, and the outer fabric layer can be satin while the inner fabric layer can be flannel.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An adjustable warming blanket comprising
a rectangular fabric outer layer having a width, a length larger than said width, first and second, parallel, opposed longitudinal edges extending along said length of said outer fabric layer, first and second parallel, opposed widthwise edges extending along said width of said outer fabric layer, and a central section extending widthwise between said opposed longitudinal edges;
a rectangular fabric inner layer stitched to said outer fabric layer by a series of angled rows of stitches defining triangular sections therebetween, said inner fabric layer being coextensive with said outer fabric layer and having first and second longitudinal edges juxtaposed, respectively, with said first and second longitudinal edges of said outer fabric layer and having first and second widthwise edges juxtaposed, respectively, with said first and second widthwise edges of said outer fabric layer;
said outer and inner fabric layers forming a two-layer rectangular fabric structure having opposing first and second longitudinal ends and having widthwise edges joined together by stitching at said first longitudinal end of said fabric structure;
a fiber filling disposed between said outer and inner fabric layers to be confined in said triangular sections; and
a zipper arrangement extending along said first longitudinal edges of said outer and inner fabric layers and along said widthwise edges at said second end of said fabric structure whereby said first longitudinal edges can be selectively joined and said second widthwise edges can be selectively joined.

2. The adjustable warming blanket recited in claim 1 wherein said outer fabric layer is made of a smooth, glossy material having a soft, slippery texture and said inner fabric layer is made of a soft, napped material.

3. The adjustable warming blanket recited in claim 2 wherein said fiber filling is made of synthetic fibers.

4. The adjustable warming blanket recited in claim 3 wherein said fabric structure is folded along said central section to produce a compact configuration.

5. The adjustable warming blanket recited in claim 3 wherein said zipper arrangement is open to produce an extended configuration for use as a shoulder wrap.

6. The adjustable warming blanket recited in claim 3 wherein said zipper arrangement is open along said first and second widthwise edges for receiving extremities therein.
